(19) United States
(12) Patent Application Publication
(10) Pub. No.: US 2008/0260895 A1
(43) Pub. Date: Oct. 23, 2008

(54) MILK REPLACER COMPOSITION AND PRODUCT AND METHOD FOR PRODUCING THE SAME

(76) Inventor: Drew A. Vermeire, Lake St. Louis, MO (US)

Correspondence Address: Patrick W. Rasche;Armstrong Teasdale LLP, Suite 2600, One Metropolitan Square, St. Louis, MO, 63102, US

(21) Appl. No.: 12/104,805

(22) Filed: Apr. 17, 2008

Related U.S. Application Data
(60) Provisional application No. 60/912,340, filed on Apr. 17, 2007.

(51) Int. Cl. A23C 11/00; A23C 21/04; A23C 11/10; A23K 1/18

(52) U.S. Cl. 426/2; 426/622; 426/648; 426/583; 426/580; 426/585

(57) ABSTRACT

A method for producing a milk replacer composition formulated for young livestock includes mixing glycerol with a powder base composition or a fluid base composition.

### CROSS REFERENCE TO RELATED APPLICATIONS

This application claims the benefit of U.S. Provisional Application No. 60/912,340, filed Apr. 17, 2007, which is hereby incorporated by reference in its entirety.

### BACKGROUND OF THE INVENTION

This disclosure relates generally to young animal feed and, more particularly, to milk replacer compositions for feeding young livestock.

Feeding young livestock, such as calves, horses, sheep, goats and other ruminants, presents unique challenges for farmers and animal feed companies. For example, the major developments in a calf's digestive tract occur in the first six months of the calf's life. This development may be influenced by the type of feed given to the calf. Further, calves are very susceptible to infections, such as scours, early in their lives.

A major component of a young animal's diet has traditionally consisted of fresh, whole milk and, more recently, milk replacers. Milk replacers primarily include milk-derived ingredients, such as dried skim milk, whey, and/or whey protein concentrate. However, the cost of milk-derived ingredients has led to the search for other ingredients to supply protein and energy in the diet of young animals.

At least some conventional methods for feeding adult cattle include using milk replacers that include ingredients that are not derived from milk. However, such conventional methods have not been utilized to feed young livestock (e.g., calves) with such milk replacers. In particular, it is commonly known by persons skilled in the art and science of animal nutrition that neonatal animals cannot effectively digest or utilize complex carbohydrates, various proteins, and/or fats and oils that are contained in many known milk replacers including ingredients that are not derived from milk. As such, there is a continuing need for alternative ingredients to be used in feed and milk replacers for young animals.

### BRIEF DESCRIPTION OF THE INVENTION

In one aspect, a method is provided for producing a milk replacer composition formulated for young livestock that includes mixing glycerol with a powder base composition or a fluid base composition to produce the milk replacer composition.

In another aspect, a method is provided for producing a milk replacer product formulated for young livestock that includes mixing glycerol with a powder base composition or a fluid base composition to produce the milk replacer product.

In another aspect, a milk replacer composition for feeding a young livestock animal is provided. The milk replacer composition includes glycerol.

In another aspect, a method is provided for feeding young livestock animals that includes feeding a young livestock animal a milk replacer product that includes glycerol.

### BRIEF DESCRIPTION OF THE DRAWINGS

FIG. 1 graphically illustrates average weights for Group 1 calves and Group 2 calves during a study.

### DETAILED DESCRIPTION OF THE INVENTION

Although embodiments of the present invention generally relate to young livestock feed, including feed for neonatal livestock, the present invention can also be used in feeding other mammals, such as humans, pets or other companion animals, and wild animals including those kept in captivity.

The term “livestock,” as used herein, includes any animal that is used for labor, food, clothing, entertainment, or research, and reared in an agricultural setting. Livestock includes, without limitation, pigs, cattle, goats, deer, sheep, horses, and buffalo.

The term “ruminants,” as used herein, includes any hooved animal reared in an agricultural setting that digests its feed with the ruminating process, including neonatal animals of ruminant species which have not fully developed the ruminant system (“preruminants”).

The term “young,” as used herein, includes the development period of an immature animal, including the neonatal period.

The term “neonatal,” as used herein, includes the first six to twelve weeks of an animal's life.

The phrase “milk replacer composition,” as used herein, not only includes milk replacers produced entirely from separate materials (i.e., “from scratch”), but also includes milk replacers made from combining commercial milk replacers or other generic milk replacers, in either powder (dry) or liquid (syrup) form.

The present disclosure describes a milk replacer composition that includes a glycerol by-product from the production of bio-diesel from soybeans. More specifically, bio-diesel fuels are produced by processing fatty acids that are removed from the triglyceride that is present in soy oil. The removal of the fatty acids from the triglyceride leaves a liquid glycerol by-product. While glycerol is generally recognized as safe for use in animal feeds and, in particular, feeds for dairy cows, current publications are silent on the use of glycerol in feeds for young livestock, such as neonatal calves. The present disclosure describes a milk replacer composition that includes glycerol and is safe for use in feeds for young livestock, such as neonatal calves. Benefits of a glycerol-based milk replacer product include increased energy content, increased digestibility, increased availability, and increased product stability.

In the exemplary embodiment, the glycerol is in a liquid form having approximately 5% moisture. The glycerol is added to a liquid base composition, such as a syrup milk replacer base composition, or a dry base composition, such as a powder milk replacer base composition, to yield a final milk replacer product suitable for feeding to young livestock, such as neonatal calves. More specifically, in the exemplary embodiment, lactose is removed from the milk replacer composition and replaced with glycerol. In one embodiment, the glycerol replaces as much as 95% of the lactose in the milk replacer composition.

Generally, milk replacer compositions contain varying levels of crude protein, crude fat, fiber, and various levels of vitamins, minerals, and amino acids. The milk replacer compositions of the present invention include adequate levels of fat, protein, vitamins, minerals, and amino acids for young livestock. Those skilled in the art possess knowledge in producing milk replacer compositions. For example, “Raising Dairy Herd Replacements” by The University of Georgia, College of Agricultural and Environmental Sciences (January 2000) provides guidelines for milk replacer compositions, as shown in Table 1.

TABLE 1
Guidelines for Milk Replacer Compositions

| | Age of Calf (days) | | |
|---|---|---|---|
| Nutrient | 4-14 | 14-21 | >21 |
| Crude Protein % | 22.0 | 22.0 | 24.0 |
| Crude Fat % | 10.0 | 10.0 | 10.0 |
| Crude Fiber % | 0.25 | 0.5 | 1.0 |
| Vitamin A | 10,000 IU/lb | 10,000 IU/lb | 10,000 IU/lb |
| Vitamin D₃ | 1,500 IU/lb | 1,500 IU/lb | 1,500 IU/lb |
| B complex | + | + | + |

Milk replacer compositions of the present invention include glycerol in amounts of 1% to 50% by weight of the composition.

In one embodiment, crude protein is added to the composition by adding at least one of whey powder, delactosed whey, whey protein concentrate, egg proteins, soy flour, soy isolate, soy concentrate, wheat isolate, wheat gluten (including hydrolyzed wheat gluten), potato protein, and/or animal plasma proteins to the composition. In an alternative embodiment, fat is added to the composition by adding at least one of lard, white grease, and/or vegetable oils, such as soy, palm, and/or coconut oil to the composition. In certain embodiments, the milk replacer composition also includes medication for the young animal, such as decoquinate, lasalocid, oxytetracycline, and/or neomycin.

Vitamins, minerals, and/or amino acids may also be added to balance the nutrient composition of the glycerol and other ingredients. For example, vitamins, minerals, and/or amino acids may be added to prevent or limit the occurrence diarrhea, poor growth, and/or weight loss associated with an allergic reaction to other plant-derived ingredients. In one embodiment, at least one of Vitamins A, D, E, K, C, B12, thiamin, riboflavin, niacin, folic acid, pantothenic acid, biotin, and/or pyridoxine is added, and/or at least one of calcium, phosphorus, potassium, sodium, chloride, sulfur, zinc, manganese, copper, iron, selenium, cobalt, and/or iodine is added, and/or at least one of lysine, threonine, methionine, and/or tryptophan is added to balance a nutrient composition of the milk replacer composition.

The example described below is merely illustrative of the methods and compositions described herein and are not intended to limit the scope of the invention as claimed.

### EXAMPLE 1

Veal calves fed milk replacer were compared to veal calves fed milk replacer including 10% glycerol to replace lactose.

Purpose: This study was conducted to compare performance of veal calves fed milk replacer to calves fed 90% milk replacer plus 10% of a new novel feed ingredient (glycerol). Glycerol is an energy source that may replace lactose in milk replacers for feeding calves. The two milk replacers were formulated to replace lactose with glycerol.

Treatments: All calves were started in Delaware, then shipped to Holland Barn and fed Belgiosio liquid milk replacer until beginning the study on May 28, 2007. Two hundred and eight calves began the study and carcass weights were collected on 190 calves on Jun. 27, 2007. Cull calves and death losses were not related to treatments.

Group 1 calves were fed a test milk replacer “A” (Brown bag with green labels). The test milk replacer (21.5% CP/21.5% Fat) was mixed to include 90% milk replacer and 10% glycerol. Group 1 calves were fed according to a feed schedule.

Group 2 calves were fed a control milk replacer “B” (Yellow labels). The control milk replacer (19% CP/19% Fat) was fed to the calves in Group 2 according to the same feed schedule for Group 1 calves.

Calves were weighed on the first day of the test (day 140), then weighed 28 days later (day 168) to ascertain growth of calves fed the two milk replacers. After the second weighing, it was determined that the formulations had been reversed and Group 2 calves were being fed milk replacer with 21.5% CP/21.5% Fat and Group 1 calves were being fed milk replacer comprised of 90% of 19% CP/19% Fat plus 10% glycerol. The formulations were switched to correct the “mistake” without changing the labels so the farm crew would not be aware of the “mistake”. Calves were then fed the “corrected” formulations and processed at Provimi Veal when they were 199 days old. Near the end of the feeding period, it was discovered that the calves were being fed reversed feed formulations at that time, so there was definitely a mistake made at that time.

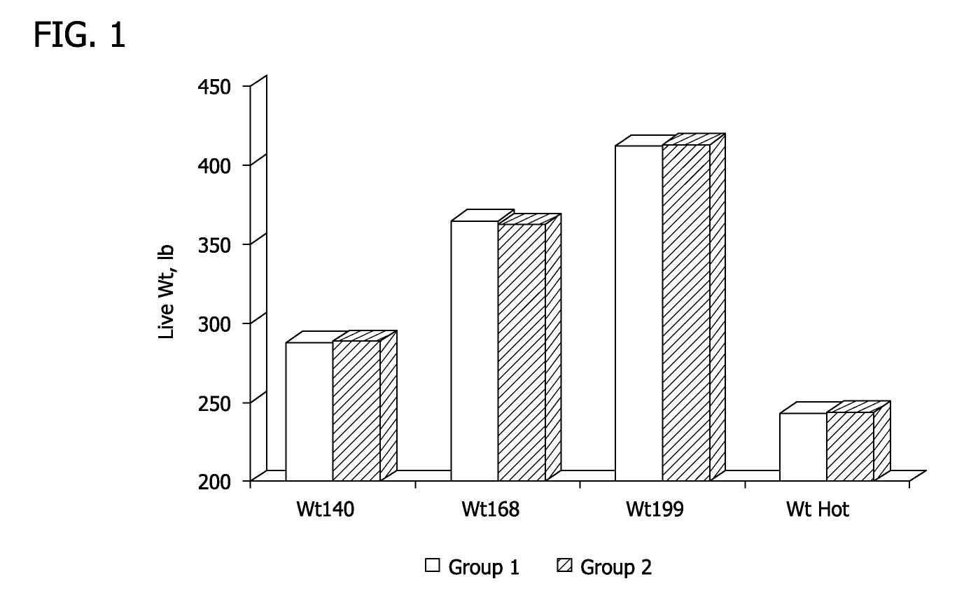

Results: Referring to FIG. 1, calves had initial weights (Day 140) of 287.58 and 288.76 lb (P=0.8019) for Groups 1 and 2, respectively. On day 168, live weights were 364.78 for calves in Group 1 and 362.65 lb for calves in Group 2 (P=0.6413). Hot carcass weights were 243.11 and 243.611b (P=0.9032) for Groups 1 and 2, respectively, with calculated live weights for calves in Groups 1 and 2 of approximately 412.05 and 412.90 lb (0.9032), respectively.

Discussion: This study illustrates the problems associated with conducting research in a production facility. The switched feed formulations illustrated problems when numerous entities are working together to conduct research. However, we do have several conclusions which can be drawn from this study.

First, there were less feed refusals when making the switch from liquid feed in the group fed the liquid ingredient (glycerol) than in the group fed dry milk replacer. Overall, both groups of calves consumed the same amount of feed per calf, so there were no differences in feed intake or feed conversion.

Secondly, regardless of the final nutrient concentration, calves in Group 1 were always fed 10% of their dry matter as glycerol. There were no observed scours or toxicity associated with calves consuming glycerol.

Thirdly, calves in Group 1 (glycerol) had essentially identical weights at all times as Group 2 calves fed the milk replacer. This is in spite of the fact that for the final 28 days, these calves were fed a lower protein/lower fat diet than calves fed the dry milk replacer. This suggests that feeding glycerol may have a “protein-sparing effect”. All calves were fed the same premix containing all supplemental vitamins and minerals at the same rate at the barn, so only protein, fat, and carbohydrate varied with the dry milk replacers and glycerol.

We have certainty that during the final 28 days, calves were either fed dry milk replacer with 21.5% CP and 21.5% fat or fed milk replacer with 17.1% CP and 17.1% fat and glycerol comprising 10% of the diet. In spite of this confounded situation, calf performance was equal for the two groups. Overall performance of the calves in this study was poor, but was equal with and without glycerol.

In one embodiment, a method for producing a milk replacer composition formulated for young livestock, such as neonatal calves, is provided. The method includes mixing glycerol with a powder base composition or a fluid base composition.

In one embodiment, a method for producing a milk replacer product formulated for feeding to young livestock is provided. The method includes mixing glycerol with a powder base composition or a fluid base composition.

In a further embodiment, a milk replacer composition formulated for feeding to young livestock includes glycerol.

In a further embodiment, a method for feeding young livestock animals, including neonatal calves, is provided. The method includes feeding the young livestock animal a milk replacer product that includes glycerol.

Described herein is a milk replacer composition that may be utilized in feeding a wide variety of young animals, such as neonatal calves. Milk replacer compositions that include glycerol offer those using milk replacers alternative ingredients that may reduce the costs in feeding the young animals.

Exemplary embodiments of a milk replacer composition and a method for feeding a young animal are described above in detail. The above-described composition and method are not limited to the specific embodiments described herein but, rather, components of the composition and/or steps of the method may be utilized independently and separately from other components and/or steps described herein.

While the invention has been described in terms of various specific embodiments, those skilled in the art will recognize that the invention can be practiced with modification within the spirit and scope of the claims.

What is claimed is:

1. A method for producing a milk replacer composition formulated for young livestock, the method comprising mixing glycerol with one of a powder base composition and a fluid base composition.

2. A method in accordance with claim 1 further comprising adding a crude protein to the milk replacer composition, wherein the crude protein is selected from the group consisting of whey powder, delactosed whey, whey protein concentrate, egg proteins, soy flour, soy isolate, soy concentrate, wheat isolate, wheat gluten (including hydrolyzed wheat gluten), potato protein, animal plasma proteins and combinations thereof.

3. A method in accordance with claim 1 further comprising adding fat to the milk replacer composition, wherein the fat is selected from the group consisting of lard, white grease, vegetable oil and combinations thereof.

4. A method in accordance with claim 1 further comprising adding a medication to the milk replacer composition, wherein the medication is selected from the group consisting of decoquinate, lasalocid, oxytetracycline, and neomycin.

5. A method in accordance with claim 1 further comprising adding at least one of a vitamin, a mineral, and an amino acid to the milk replacer composition to balance a nutrient composition of the milk replacer composition.

6. A method in accordance with claim 1 further comprising adding at least one of Vitamin A, Vitamin D, Vitamin E, Vitamin K, Vitamin C, Vitamin B12, thiamin, riboflavin, niacin, folic acid, pantothenic acid, biotin, and pyridoxine to the milk replacer composition.

7. A method in accordance with claim 1 further comprising adding at least one of calcium, phosphorus, potassium, sodium, chloride, sulfur, zinc, manganese, copper, iron, selenium, cobalt, and iodine to the milk replacer composition.

8. A method in accordance with claim 1 further comprising adding at least one of lysine, threonine, methionine, and tryptophan to the milk replacer composition to balance a nutrient composition of the milk replacer composition.

9. A method in accordance with claim 1 further comprising removing as much as 95% of a quantity of lactose from the milk replacer composition.

10. A method in accordance with claim 9 further comprising replacing the removed lactose with the glycerol.

11. A method for producing a milk replacer product formulated for young livestock, the method comprising mixing glycerol with one of a powder base composition and a fluid base composition.

12. A method in accordance with claim 11 further comprising adding at least one of a crude protein, a fat, and a medication to the base composition.

13. A method in accordance with claim 11 further comprising adding at least one of a vitamin, a mineral, and an amino acid to the base composition to balance a nutrient composition of the milk replacer product.

14. A method in accordance with claim 11 further comprising adding at least one of Vitamin A, Vitamin D, Vitamin E, Vitamin K, Vitamin C, Vitamin B12, thiamin, riboflavin, niacin, folic acid, pantothenic acid, biotin, and pyridoxine to the base composition.

15. A method in accordance with claim 11 further comprising adding at least one of calcium, phosphorus, potassium, sodium, chloride, sulfur, zinc, manganese, copper, iron, selenium, cobalt, and iodine to the base composition.

16. A method in accordance with claim 11 further comprising adding at least one of lysine, threonine, methionine, and tryptophan to the base composition to balance a nutrient composition of the milk replacer product.

17. A method in accordance with claim 11 further comprising removing as much as 95% of a quantity of lactose from the base composition.

18. A method in accordance with claim 17 further comprising replacing the removed lactose with the glycerol.

19. A milk replacer composition for feeding to a young livestock animal, the milk replacer composition comprising glycerol.

20. A milk replacer composition in accordance with claim 19 wherein the glycerol comprises a liquid glycerol by-product from a production of bio-diesel from soybeans.

21. A milk replacer composition in accordance with claim 19 wherein the glycerol is in a liquid form having approximately 5% moisture.

22. A milk replacer composition in accordance with claim 19 wherein the glycerol is added to one of a liquid base composition and a dry powder base composition to yield the milk replacer composition suitable for feeding to neonatal calves.

23. A milk replacer composition in accordance with claim 19 wherein the milk replacer composition comprises glycerol in an amount of 1% to 50% by weight of the milk replacer composition.

24. A method for feeding young livestock animals comprising feeding a young livestock animal a milk replacer product comprising glycerol.
